(19) United States
(12) Patent Application Publication
(10) Pub. No.: US 2008/0104853 A1
(43) Pub. Date: May 8, 2008

(54) Reciprocating saw with a shield member

(76) Inventor: Josef Hunger, Fuchstal (DE)

Correspondence Address: ABELMAN, FRAYNE & SCHWAB, 666 THIRD AVENUE, 10TH FLOOR, NEW YORK, NY, 10017, US

(21) Appl. No.: 11/974,243

(22) Filed: Oct. 11, 2007

(30) Foreign Application Priority Data
Oct. 12, 2006 (DE) 10 2006 035 343.9

(51) Int. Cl. B23D 49/00

(52) U.S. Cl. 30/392

(57) ABSTRACT

A reciprocating saw includes a reciprocatingly driven working tool assembly (6) having a working tool receptacle (10) for securing a saw blade (12), a housing (4) extending along a reciprocation axis (A) of the working tool assembly (6) and forming a saw neck (14) enclosing a housing opening (18) through which a section of the working tool assembly (6) reciprocates, a securing element (28) provided on a first side (26) of the working tool assembly (6) for securing an auxiliary guide means (32), and a shield member (36) separate from the auxiliary guide means (32) and securable on a second side (34) of the working tool assembly (6) and extending from a working tool-side end (16) of the saw neck (14) away over at least a section of the working tool assembly (6) extending from the house opening (18).

### BACKGROUND OF THE INVENTION

1. Field of the Invention

The present invention relates to a reciprocating saw, e.g., to an electrical reciprocating saw such as a saber saw, and which includes a reciprocatingly driven working tool assembly having a working tool receptacle for securing a saw blade and a housing extending along a reciprocation axis of the working tool assembly and forming a saw neck which serves regionwise as a hand-hold and which encloses a housing opening through which a section of the working tool assembly reciprocates, with securing means provided on a first side of the saw neck, with respect to the working tool assembly, for securing an auxiliary guide means.

2. Description of the Prior Art

Generally, reciprocating saws of the type described above are held during an operation with a hand put on the hand-hold of the saw neck, with the thumb and forefinger of the holding hand being put on the working tool-side end of the hand-hold.

U.S. design Pat. D 524,130 shows a saber saw with a saw neck that sectionwise, serves as a hand-hold. The working tool-side end of the saw neck is provided with a collar that surrounds the opening of the saw neck through which the working tool assembly reciprocates. When the saw is held by the hand put on the hand-hold, the forefinger or the thumb of the holding hand lies against the collar. Further, a guide shoe is connected with the saw housing by a support. The support extends substantially parallel to the reciprocation axis of the tool receptacle from a lower or bottom side of the hand-hold away. In the contemplated holding position of a hand, the thumb of the holding hand lies against the collar, and the forefinger lies on the bottom side of the saw neck.

The drawback of the saw of U.S. design Pat. D 524,130 consists in that when the precautionary measures, such as wearing the protection gloves, are not observed, during an operation, a finger, in particular the thumb or the small finger can slip over the collar in the region of the working tool receptacle.

Further, U.S. design Pat. D 523,310 shows a saber saw in which an adapter is mounted on the saw neck. The adaptor serves, on one hand, for securing the saw blade and, on the other hand, the adaptor housing functions as guide means.

The adapter provides a certain protection against an inadvertent gripping of the working tool receptacle. However, in cases where the adaptor is removed, this protection is not any more available.

Accordingly, an object of the invention is to provide a reciprocating saw, e.g., an electrical reciprocating saw in which the foregoing drawback of the known reciprocating saw is eliminated.

Another object of the present invention is to provide a reciprocating saw with a reliable positioning of the holding hand on the saw neck.

### SUMMARY OF THE INVENTION

This and other objects of the present invention, which will become apparent hereinafter, are achieved by providing a shield member separate from the auxiliary guide means and securable on a second side of the working tool assembly and extending from a working tool-side end of the saw neck away over at least a section of the working tool assembly extending from the house opening.

The shield member shields, at least partially, the working tool assembly from being engaged by the saw holding hand, independent from the auxiliary guide means that can function as an additional protection from an undesirable engagement of the working tool assembly with the saw holding hand during an operation of the saw. The shield member, which provides an additional shielding of the working tool assembly, offers additional support for the saw holding hand and can be formed integrally with or separately from the hand-hold. In order to insure a reliable placement of the holding hand on the shield member, e.g., rubber pimples, riffles, finger recesses or similar known means, which insure a better grip, can be provided.

According to a particularly advantageous embodiment of the present invention, the shield member is formed as one piece with the hand-hold. In this way, the shield member can be cost-effectively produced and mounted, together with the hand-hold, e.g., by an injection-molding process. A portion of the saw neck that forms the hand-hold can be formed integrally with the remaining portion of the saw neck, or be formed as a separate element which, preferably, is formed of a relatively softer material the remaining part of the housing. Simultaneously, it is insured that the shield member permanently remains on the reciprocating saw, insuring, thus, a permanent protection.

Advantageously, the shield member is formed on a collar of the hand-hold which extends transverse to the reciprocation axis. Such a collar, provides for a comfortable positioning of the thumb or the forefinger of the holding hand and, thereby, insures a reliable positioning of the holding hand. The shield member also insures a reliable position of the holding hand even when the holding hand partially slips over the collar in case when the precautionary measures, such as wearing the protection gloves, are not observed.

Advantageously, the shield member extends about the reciprocating axis over an angular region of at least 90°. Thereby, the working tool receptacle is completely shielded on one side. Thereby, effective additional support possibilities are provided for the holding hand. Simultaneously, as a result of a limited extension of the shield member, unnecessary, during an operation, obstacles, e.g., cause by tilting, are prevented.

Preferably, the shield member extends, with respect to the working tool assembly, on a side of the housing remote from the auxiliary guide means, away therefrom. In this way, the working tool assembly can be shielded by the auxiliary guide means on the first side and by the shield member on the opposite second side. In this case, additional reliable support possibilities can become available for both the thumb and the forefinger.

In a particular advantageous embodiment of the present invention, the shield member is arranged at a height of a stroke path of the working tool receptacle over which the working tool receptacle reciprocates. In this way, during an operation, a reliable position of the holding hand with respect to the working tool receptacle is insured.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a perspective view of a working tool-side end of a reciprocating saw according to the present invention;

FIG. 2 a longitudinal cross-sectional view of the reciprocating saw shown in FIG. 1; and

FIG. 3 an end view of the reciprocating saw in plane III-III in FIG. 2.

### DETAILED DESCRIPTION OF THE PREFERRED EMBODIMENT

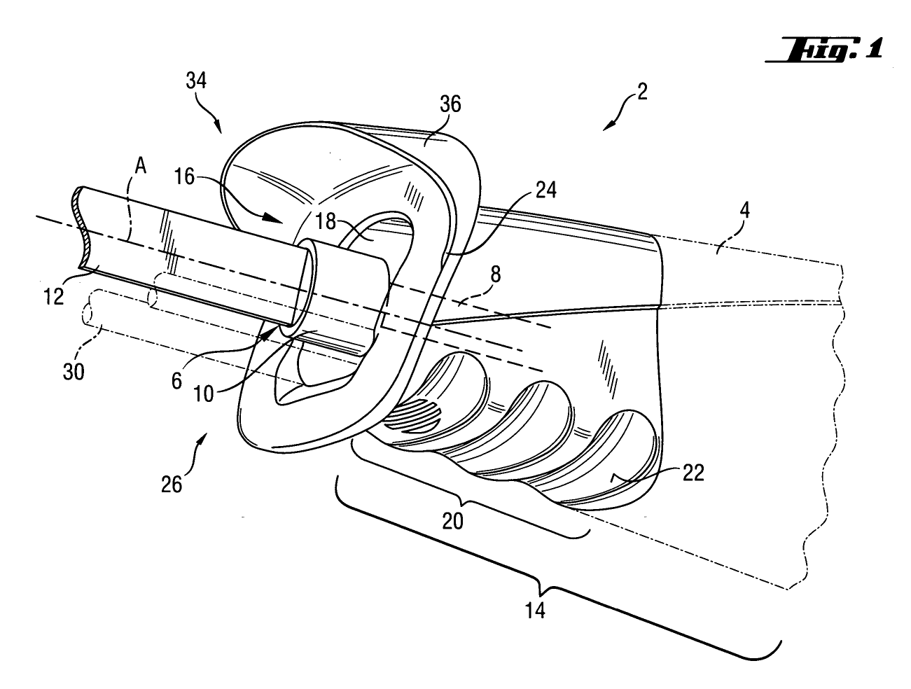

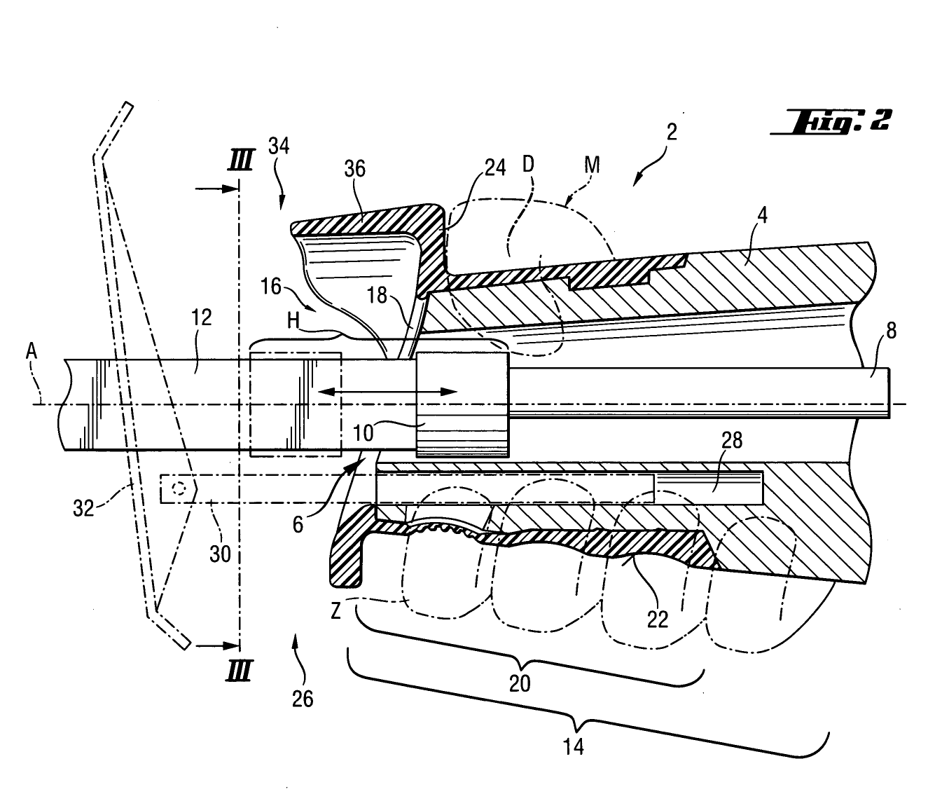

FIGS. 1-2 show, as discussed above, a working tool-side end of a reciprocating saw 2 according to the present invention which is formed as a saber saw. The saw 2 has a housing 4 that substantially extends along the reciprocation axis A. A working tool assembly 6, which includes a working tool receptacle 10 driven by a spindle 8, reciprocates along the reciprocation axis A. In the tool receptacle 10, a saw blade 12 is secured.

The housing 4 forms a saw neck 14 that encloses a housing opening 18 at the working tool-side end 16. Through the housing opening 18, the working tool receptacle 10 reciprocates along a stroke path H, as particularly shown in FIG. 2.

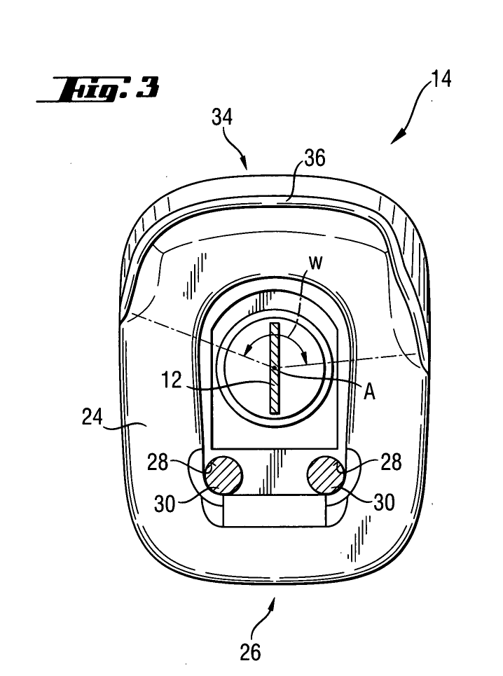

As further particularly shown in FIG. 2, the saw neck 14 has a hand-hold 20 for a hand M. The hand-hold 20 can either be formed integrally with the saw neck 14 or be formed as a separate element, preferably, of a softer material than the remaining part of the housing 4. A plurality of grip recesses 22 is formed in the hand-hold 20. The saw neck 14 further has a collar 24 that mainly extends transverse to the reciprocation axis A and on which at least the thumb of the hand M can be put. Further, as it is particularly shown in FIGS. 2-3, there is provided, on the saw neck 14 on a first side 26 of the working tool assembly 6 that forms during normal operation of the reciprocating saw 2, a bottom side, securing means 28 in form of two cylindrical openings. In the securing means 28, two rod-shaped support elements 30 of auxiliary guide means 32 in form of a guide shoe are secured.

On a second side 34 remote from the first, bottom side 32 and forming, during normal operation of the reciprocating saw 2, an upper side with respect to the working tool assembly 6, there is provided a shield member 36. The shield member 36 extends substantially parallel to the reciprocation axis A and away from the collar 24 and, in the radial direction, about the reciprocation axis A over an angular region W of at least 90°, as shown in FIG. 3.

The shield member 36 insures that the thumb D, which is put on the second side 34, or the small finger, with the hand M being pivoted by 180°, would not inadvertently engage the working tool assembly 6, even when the precautionary measures, such as wearing the protection gloves, are not observed. To this end, the shield member 36 is arranged at a height with respect to the reciprocation axis A over the stroke path H. When the auxiliary guide means 32 is used, the support elements 30 insure that the forefinger Z, which is put on the first side 26, would not inadvertently reach in the stroke path H of the working tool assembly.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A reciprocating saw, comprising:
a reciprocatingly driven working tool assembly (6) having a working tool receptacle (10) for securing a saw blade (12);
a housing (4) extending along a reciprocation axis (A) of the working tool assembly (6) and forming a saw neck (14) having a hand-hold (20) and enclosing a housing opening (18) through which a section of the working tool assembly (6) reciprocates;
securing means (28) provided on a first side (26) of the working tool assembly (6) for securing an auxiliary guide means (32); and
a shield member (36) separate from the auxiliary guide means (32) and securable on a second side (34) of the working tool assembly (6) and extending from a working tool-side end (16) of the saw neck (14) away over at least a section of the working tool assembly (6) extending from the house opening (18).

2. A reciprocating saw according to claim 1, wherein the shield member (36) is formed integrally with the hand-hold (20).

3. A reciprocating saw according to claim 2, wherein the shield member (36) is formed on a collar (24) of the hand-hold (20) which extends transverse to the reciprocation axis (A).

4. A reciprocating saw according to claim 1, wherein the shield member (36) extends about the reciprocating axis (A) over an angular region (w) of at least 90°.

5. A reciprocating saw according to claim 1, wherein the shield member (36) is arranged, on a side of the housing (4) remote with respect to the working tool assembly (6), from the securing means (28).

6. A reciprocating saw according to claim 1, wherein the shield member (36) is arranged at a height of a stroke path (H) of the working tool receptacle (10).
